(19) United States
(12) Patent Application Publication
(10) Pub. No.: US 2022/0241918 A1
(43) Pub. Date: Aug. 4, 2022

(54) A Dust Container Arrangement for Construction Sites

(71) Applicant: HUSQVARNA AB, HUSKVARNA (SE)

(72) Inventors: Fredrik Karlsson, Sävedalen (SE); Anders Reuterberg, Lerum (SE); Johan Sandwall, Gråbo (SE); Tobias Gustafsson, Göteborg (SE)

(21) Appl. No.: 17/610,349

(22) PCT Filed: May 14, 2020
(86) PCT No.: PCT/SE2020/050497

§ 371 Date: Nov. 10, 2021

(30) Foreign Application Priority Data
Jun. 5, 2019 (SE) 1950663-3

(51) Int. Cl. B23Q 11/00; B01D 46/02; B01D 46/48; B01D 46/00; B01D 46/42

(52) U.S. Cl. CPC B23Q 11/0046; B01D 46/02; B01D 46/48; B01D 46/0043; B28D 1/045; B01D 46/4272; B01D 46/4227; B01D 46/4245; B01D 46/0005

(57) ABSTRACT

The present disclosure relates to a dust container arrangement (15, 120, 210) adapted to be fluidly coupled to a fan arrangement (13) comprised in a power tool (1) via an at least partly flexible dust conduit (14). The dust container arrangement (15, 120, 210) comprises a frame (100, 126) which in turn comprises a holder part (102, 123) with a container inlet (101, 125). The dust container arrangement (15, 120, 210) further comprises a first container (107, 121) and a second container (108), which containers (107, 108; 121) are releasably attached to the holder part (102, 123) in a sealed manner. The first container (107, 121) is air-permeable such that air (A1) that is blown into the container inlet (101, 125) is permitted to escape through a wall (115 132) of the first container (107, 121), while the second container (108) is air-tight during operation and adapted to receive dust (113A, 113B, 113C) that is brought into the container inlet (101, 125).

### TECHNICAL FIELD

The present disclosure relates to dust container arrangements adapted to be fluidly coupled to fan arrangements comprised in construction equipment such as, power tools, floor saws, and floor grinders. The dust container arrangements may be coupled to the construction equipment via an at least partly flexible dust conduit or be mounted directly onto the construction equipment.

### BACKGROUND

Many motor tools such as engine-driven handheld cutting machines have saw blades which may be circular or ring-shaped. Such a cutting machine may be used for cutting hard materials such as concrete or rock, where the cutting procedure may result in the creation of dust. Dust is also generated when floor saws and floor grinders are used to process concrete surfaces. Concrete dust is unhealthy to breathe and also impairs operator vision, and it is desired to minimize the creations of such dust that freely may expand in the air. Such free concrete dust that finds its way into the engine of the tool drastically affects the engine in a negative way, may cause undesirable health effects and generally pollutes the environment.

Many tools of the above type are for this purpose equipped with a water supply, where a flow of water is directed towards the saw blade or grinding device in such a way that a large quantity of the dust is mixed with the water and thus retained and kept from expanding in the air. Since the water normally has to be taken care of at the working site, more water than necessary is undesirable. Thus, the flow of water is preferably held at a minimum. At some working sites, a demand for cleanliness, or shortage of water, results in that such a water supply is undesired. For this purpose, many types of dust removal systems of vacuum cleaner type have been developed.

WO2018084771 describes a dust container with an electrically driven fan, where the power needed to drive the fan is generated by the movement of an electrical generator at a power cutter that is fluidly coupled to the dust container and has an engine that is arranged to at least indirectly drive the generator.

Some dust removal systems have an integrated fan for propelling air into a dust hose that guides undesired dust particles to a remote dust container. These fans are normally propelled by means of a transmission arrangement that is connected to the cutting machine's main engine, and comprises one or more drive belts or geared transmissions, for example as described in U.S. Pat. No. 6,039,037.

WO 2008084784 describes an engine-driven tool that comprises a blade guard that is arranged to shield a part of the rotatable work tool, and a dust channel that is formed between the blade guard and the rotatable work tool. The dust channel is at least indirectly connected to a fan arrangement that is arranged to convey air from the dust channel and comprises a fan turbine that is connected to a fan pulley comprised in the power transferring unit. The drive belt is arranged to propel the fan pulley. When the fan pulley is in a tensioned state, the drive belt is tensioned and arranged to drive both the fan pulley and the rotatable work tool, and when the fan pulley is in a released state, the tension of the drive belt is released.

However, a dust container normally comprises a dust bag that will become filled with dust such that the dust bag needs to be changed. Such dust bags are normally quite expensive and can sometimes be difficult to keep tight during removal which results fine dust being accidentally released which is highly undesired.

### SUMMARY

An object of the present disclosure is to provide a dust container arrangement that is versatile, easily moved along at a work site, and enables a more inexpensive and dust secure handling, thus providing reliable removal of dust, and minimizing the amount of dust that is released in surrounding air.

This object is achieved by means of a dust container arrangement adapted to be fluidly coupled to a fan arrangement comprised in a piece of construction equipment, such as a power tool. Some versions of the herein disclosed dust container arrangements are arranged to be connected to the construction equipment via an at least partly flexible dust conduit, while other versions are adapted for mounting directly onto the construction equipment. According to some aspects, the dust container arrangements are arranged to be towed behind the construction equipment.

The dust container arrangement comprises a frame which in turn comprises a holder part with a container inlet. The dust container arrangement further comprises a first container and a second container, which containers are releasably attached to the holder part in a sealed manner. The first container is air-permeable such that air that is blown into the container inlet is permitted to escape through a wall of the first container, while the second container is air-tight during operation and adapted to receive dust that is brought into the container inlet.

In this manner, a more reliable collecting of dust is provided, minimizing dust that is released in surrounding air. The dust container arrangements disclosed herein are of a passive type, being adapted to be fluidly coupled to a fan arrangement comprised in the piece of construction equipment, which results in that the dust container arrangement is easily handled and moved, not needing any separate power source.

The passive type of dust container arrangements discussed herein are not to be confused with known active dust container arrangements disclosed in, e.g., US 20160031054 and U.S. Pat. No. 8,110,025. These active dust container arrangements comprise powered fans and therefore require a power source such as mains electricity, which may not be available at a construction site. An active dust container arrangement of this type is not adapted to be fluidly coupled to a fan arrangement comprised in a piece of construction equipment, since the fan or impeller used to drive the active dust collector blocks the air flow generated by the construction equipment and thereby prevents sufficient fluid coupling.

According to some aspects, in an operating state, the containers are located on opposite sides of the holder part and are preferably releasable.

According to some aspects, the second container constitutes a barrier towards ambient atmospheric pressure during operation.

According to some aspects, the second container is constituted by a plastic bag and is comprised in an elongated rolled-up or folded plastic tube that gradually is adapted to be unrolled or unfolded when one second container is to be changed, where each second container is closed at its bottom with a bottom sealing means.

In this way, an uncomplicated handling of the second container is enabled, minimizing the risk of undesired release of dust.

According to some aspects, when a used second container is to be changed, it is adapted to be closed at its top with a top sealing means, and the following new second container is adapted to be closed at its bottom with a new bottom sealing means before the second containers are separated from each other by means of a cut in between the top sealing means and the new bottom sealing clamp.

In this way, an uncomplicated change of the second container is enabled, minimizing the risk of undesired release of dust.

According to some aspects, the dust container arrangement comprises a one-way valve arranged at the container inlet and being adapted to prevent air and dust to flow from the dust container arrangement, in a direction that is opposite the air and dust flow direction during operation, via the container inlet.

In this way, the risk of undesired release of dust when operation is discontinued is minimized.

According to some aspects, the frame further comprises a mobility assembly, where the holder part is attached to the mobility assembly by a non-permanent or permanent fastening method. Preferably, the mobility assembly comprises a handle attached to the holder part. According to some further aspects, the mobility assembly comprises a frame and wheels.

In this way, an easy handling of the dust container arrangement is enabled.

According to some aspects, the mobility assembly further comprises supporting means and a base part, where the wheels are attached to the base part where the holder part is attached to the base part via the supporting means.

In this way, a rigid dust container arrangement is provided.

According to some aspects, the second container is adapted to run between the holder part and the base part.

In this way, the second container receives dust that is brought into the container inlet in a reliable manner.

According to some aspects, the air pressure at the container inlet during operation exceeds the ambient atmospheric pressure with less than 0.05 Bar, preferably with less than 0.03 Bar, and even more preferably with less than 0.01 Bar. According to some aspects, the air pressure at the container inlet during operation exceeds the ambient atmospheric pressure with less than 0.005 Bar.

According to some further aspects, a maximum air pressure at the container inlet exceeds the ambient atmospheric pressure with less than 0.1 Bar, preferably with less than 0.07 Bar, and even more preferably with less than 0.05 Bar.

In this way, that the first container is kept expanded during operation.

According to some aspects, the dust container arrangement is adapted to be fluidly coupled to a fan arrangement that is arranged to convey air towards the dust container arrangement and comprises a fan turbine that is connected to a fan pulley, where a drive belt comprised in the construction equipment is arranged to propel the fan pulley.

In this way, an uncomplicated and reliable fan arrangement is provided that is adapted to supply a desired air pressure at the container inlet during operation.

According to some aspects, the dust container arrangement is adapted to be fluidly coupled to a fan arrangement that is arranged to convey air towards the dust container arrangement, where the fan arrangement comprises an electric motor that is powered by means of a battery.

In this way, the dust container arrangement is adapted for a battery-powered piece of construction equipment.

According to some aspects, in an idle state, the first container is adapted to be depressed and stored in the holder part.

In this way, an easy handling of the dust container arrangement is enabled, while the first container is protected when not in use.

According to some aspects, the wall of first container is made in a material with permeable characteristics that, at a maximum air flow for air that is blown into the container inlet, provides a filtering degree of one of:

at least 99.997% for all particles having a size of, or exceeding, 0.3 μm,

at least 99.99% for all particles having a size of, or exceeding, 0.3 μm, or

at least 99.97% for all particles having a size of, or exceeding, 0.3 μm.

According to some aspects, the maximum air flow for air that is blown into the container inlet lies between 30 liters/second (l/s) and 80 l/s, preferably between 40 l/s and 70 l/s, and most preferably between 50 l/s and 60 l/s.

In this way, the first bag is kept expanded during operation.

According to some aspects, the first container has a shape where a largest cross-sectional area in a plane perpendicular to a longitudinal extension of the first container is present at a first distance from the holder part and a second distance from a top of the first container, the top being a part of the first container adapted to be positioned farthest away from the holder part, where the first distance falls below second distance.

In this way, the first bag is more easily kept expanded during operation.

According to some aspects, the largest cross-sectional area of the first container exceeds a cross-sectional area of the holding part in a plane perpendicular to the longitudinal extension.

According to some aspects, the dust container arrangement comprises a supporting device that is adapted to maintain the first container in an expanded position.

In this way, the first bag is more easily kept expanded during operation.

The present disclosure also relates to a tool system that is associated with above advantages.

According to aspects, the mobility assembly comprises wheels arranged to support the mobility assembly on concrete during an early entry sawing process. These wheels are generally larger and softer compared to other wheels, thereby providing both increased stability and less marks on an uncured concrete surface. For example, the wheels may be configured with a diameter D between 5-40 cm, and preferably about 10 cm. The wheels may also be configured with a width W between 5-15 cm, and preferably about 7 cm in order to provide said stability and to be able to roll on soft concrete without leaving marks.

According to aspects, the wheels are coated in a resilient material, such as rubber or soft plastic. These wheels resemble the wheels on a skateboard and allow the dust container to roll over soft surfaces without leaving marks, and with an improved stability.

According to aspects, the mobility assembly also comprises a drawbar arrangement arranged to couple to construction equipment configured to tow the dust container arrangement. This drawbar arrangement allows for hitching the dust container to construction equipment arranged to tow the dust container arrangement. Thus, the dust container is conveniently moved in the same pace as the construction equipment and in the same general direction. The drawbar arrangement is optionally configured with an arcuate shape in order to allow an operator to walk behind the towing machine without hindrance from the drawbar.

According to aspects, the dust container arrangement is arranged to be fixedly mounted onto the construction equipment. A drawbar with or without the mobility assembly may be mounted directly ono the construction equipment. This is an advantage since no towing is required.

According to aspects, the dust container arrangement is arranged to be mounted onto an early entry floor saw arranged to support two or more dust container arrangements to maintain a clear operator line of sight towards a section of floor surface in front of the construction equipment. It is an advantage that a clear line of sight is maintained, while at the same time a high dust collection capacity is maintained due to the dual dust containers.

The herein disclosed dust container arrangements may also be used together with, e.g., floor saws, floor grinders, floor polishing systems and the like. The dust container arrangement may be mounted in connection to both front and rear sections of the construction equipment, with associated advantages. For instance, in case the construction equipment comprises a circular saw blade arranged for up-cut operation, the dust collector arrangement is preferably arranged to be mounted on a rear section of the construction equipment relative to a main operating direction. Also, in case the construction equipment comprises a saw blade arranged for down-cut operation the dust collector arrangement is preferably arranged to be mounted on a front section of the construction equipment relative to a main operating direction.

### BRIEF DESCRIPTION OF THE DRAWINGS

The present disclosure will now be described more in detail with reference to the appended drawings, where:

FIG. 1 shows a side view of a hand-held power cutter;

FIG. 2 shows a schematic front view of a part of the saw blade in the blade guard;

FIG. 3 shows a perspective front view of a fan arrangement with a cover;

FIG. 4 shows a perspective front view of a fan arrangement without a cover;

FIG. 5 shows a perspective front view of a first example of a power transferring unit with a belt in a tensioned state;

FIG. 6 shows a perspective front view of the first example of a power transferring unit with a drive belt in a released state;

FIG. 7 shows a perspective front view of a second example of a power transferring unit with a belt in a tensioned state;

FIG. 8 shows a perspective front view of the second example of a power transferring unit with a drive belt in a released state;

FIG. 9 shows a front view of dust container arrangement according to the present disclosure in an idle state;

FIG. 10 shows a front view of dust container arrangement according to the present disclosure in an active state;

FIG. 11 shows a front view of dust container arrangement according to the present disclosure where a second bag is being replaced; and

FIG. 12 shows a person carrying a tool system according to the present disclosure;

FIG. 13 shows a side view of an alternative dust container arrangement with a first bag;

FIG. 14 shows a side perspective view of the alternative dust container arrangement;

FIG. 15 shows a top view of the alternative dust container arrangement without bags;

FIG. 16 shows a top perspective view of the alternative dust container arrangement without bags;

FIG. 17 shows a side view of the alternative dust container arrangement without bags;

FIG. 18 shows a person carrying a tool system according to the present disclosure;

FIG. 19 shows a side view of a battery-operated hand-held power cutter;

FIG. 20 shows a front view of dust container arrangement according to the present disclosure in an active state;

FIG. 21 shows a wheel for a dust container arrangement base part;

FIG. 22 shows a side view of dust container arrangement towing means;

FIG. 23 shows a top view of dust container arrangement towing means;

FIG. 24 illustrates an example early entry floor saw;

FIG. 25 illustrates an example floor grinder;

FIG. 26 illustrates an example floor saw;

FIG. 27 illustrates an example floor saw;

FIG. 28 illustrates an example early entry floor saw;

FIG. 29 illustrates an example floor grinder; and

FIG. 30 illustrates an example floor grinder;

### DETAILED DESCRIPTION

Aspects of the present disclosure will now be described more fully hereinafter with reference to the accompanying drawings. The different devices, tools and equipment can, however, be realized in many different forms and should not be construed as being limited to the aspects set forth herein. Like numbers in the drawings refer to like elements throughout.

The terminology used herein is for describing aspects of the disclosure only and is not intended to limit the invention. As used herein, the singular forms “a”, “an” and “the” are intended to include the plural forms as well, unless the context clearly indicates otherwise.

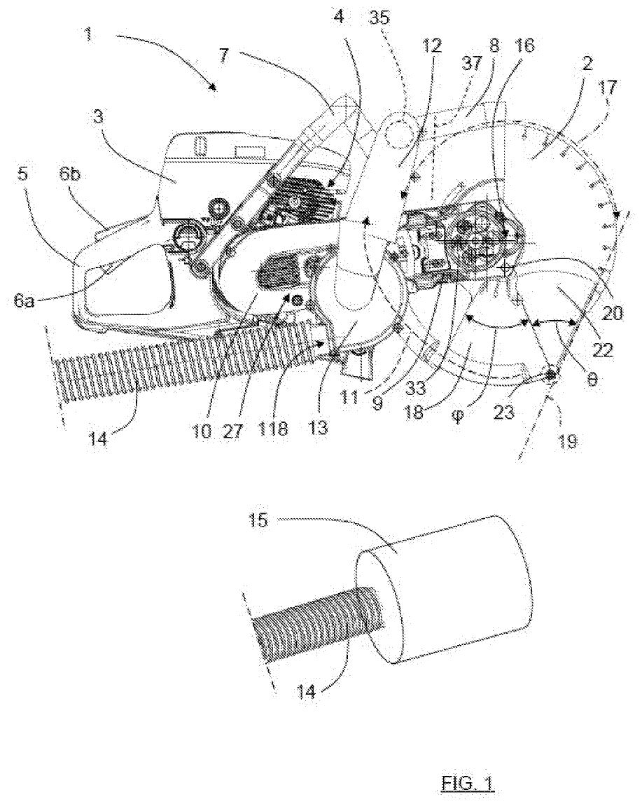

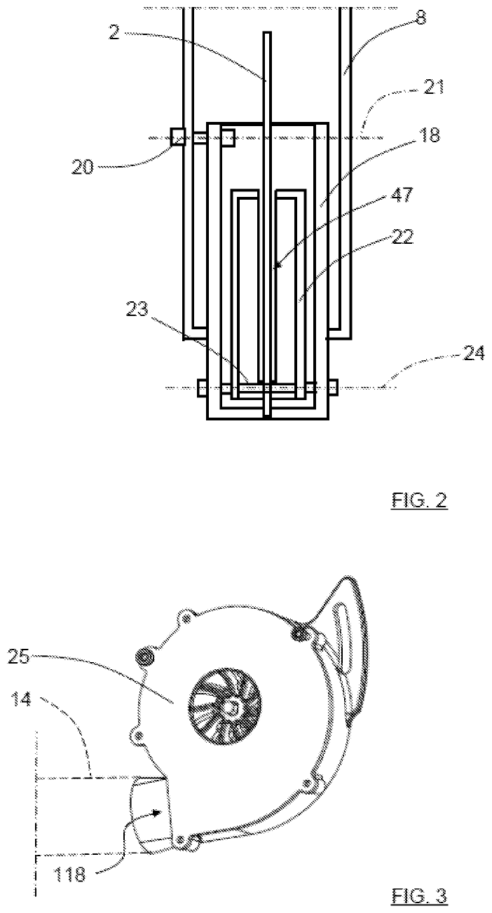

FIG. 1 and FIG. 2 show respective side views of a hand-held power cutter 1 with a circularly shaped saw blade 2, for example suitable to cut through concrete. The saw blade 2 has a center 16 and a circumference 17 (only schematically indicated). The power cutter 1 comprises a casing 3 at least partly enclosing a combustion engine 4, where the casing 3 in turn comprises a first handle part 5 from which a throttle trigger 6a and corresponding safety button 6b is accessible. The power cutter 1 further comprises a second handle part 7 that runs in an arcuate shape over the casing 3, the second handle part 7 being attached to the casing 3 via means that attenuate vibrations in a well-known manner.

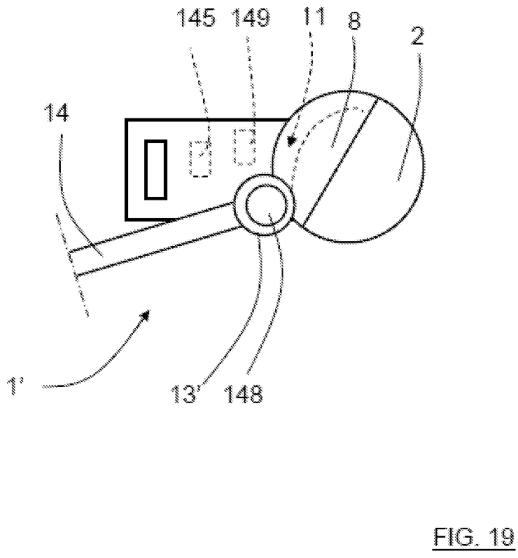

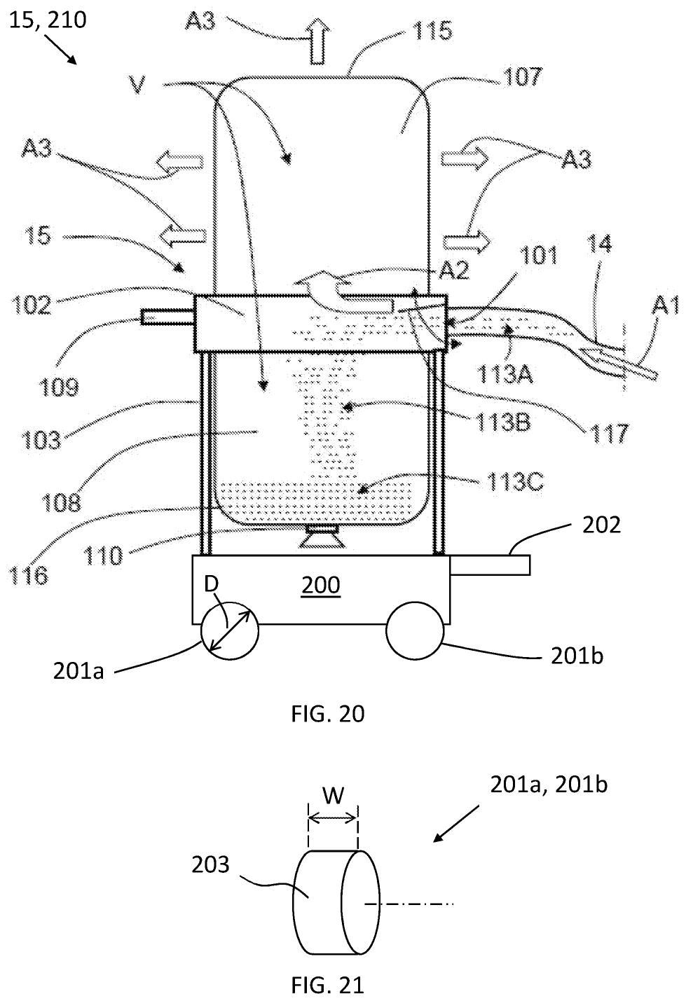

A power tool such as the power cutter 1 is an example of a piece of construction equipment. Other types of construction equipment will be discussed below, e.g., in connection to FIGS. 20-30. It is appreciated that most of the features discussed herein can be used in combination with both power tools such as power cutters, floor saws, floor grinder, and more general construction equipment.

The power cutter 1 comprises a blade guard 8 that is arranged to shield a part of the saw blade 2. The saw blade 2 is connected to the engine 4 via a power transferring unit 27 that comprises a power transferring means 9 that is covered by a power transfer cover 10. The power transferring means 9 is according to some aspects either in the form of an endless drive belt or a geared transmission, or a combination of both. Here, a drive belt 9 is shown, driving a second drive pulley 33 that in turn is arranged to propel the saw blade 2. The power transferring unit 27 can also be referred to as a clutch side crank case.

A dust channel 11 is formed between the blade guard 8 and the saw blade 2, where a dust pipe 12 is connected between an upper part of the blade guard 8 and a fan arrangement 13 that is adapted to lower the air pressure at the dust pipe 12 such that air is conveyed from the dust pipe 12 and further into a hose 14. According to some aspects, the dust channel 11 is connected to the dust pipe 12 via an aperture 35, where the aperture 35 is positioned outside the circumference 17 of the saw blade 2. In view of the distance that the dust which forms during sawing operation is propelled, and the normal rotational speed of the saw blade during operation, the aperture 35 has an advantageous position in order to enable as much dust as possible to be removed from the dust channel 11 via the dust pipe 12. Furthermore, in order to even more increase the amount of dust that is removed from the dust channel 11 via the dust pipe 12, a separating wall 37 is formed in shielding cover 8 with a slot aperture for the saw blade 2. The separating wall 37 prevents dust that has not immediately been conveyed into the dust pipe 12 from following the motion of the saw blade 12, escaping the shielding cover 8 and getting into the environment.

The hose 14 is arranged to be connected between the fan arrangement 13 and a dust container arrangement 15 that is only schematically indicated in FIG. 1, not being shown in actual size and configuration and which will be described more in detail later. The dust container arrangement 15 is arranged to receive the dust that has been propelled from the dust channel 11 by means of the fan arrangement 13 such that an operation that is similar or the same as the operation of a vacuum cleaner is obtained.

According to aspects, the hose is an anti-static hose configured to resist build-up of electric charge, i.e., static. Such hoses are generally known and will not be discussed in more detail herein.

When the power cutter 1 is in operation and the saw blade 2 for example is cutting through concrete, a lot of concrete dust is formed. By means of the fan arrangement 13 and the dust hose 14, the concrete dust is conveyed from the dust channel 11 in the blade guard 8 to the dust container arrangement 15. In order to obtain a proper functionality, it is desired that the amount of dust that escapes the dust channel 11 in the blade guard 8 is minimized, and therefore, according to some aspects and with reference also to FIG. 2, a first swiveling part 18 is attached to the blade guard 8 such that a self-adjusting cover is obtained between the power cutter 1 and a work surface 19, the work surface 19 being schematically indicated with a dash-dotted line in FIG. 1.

In this example, the first swiveling part 18 is attached to the blade guard 8 by means of a first swivel attachment 20 allowing the first swiveling part 18 to pivot around a first swivel axis 21 that crosses the saw blade 2 closer to the center 16 of the saw blade 2 than the circumference 17 of the saw blade 2. The first swiveling part 18 can be attached to any suitable part such the blade guard 8 as shown in FIG. 2.

According to some further aspects, a second swiveling part 22 is attached to the first swiveling part 18 such that an improved self-adjusting combined cover between the power cutter 1 and the work surface 19 is obtained. The second swiveling part 22 is attached to the first swiveling part 18 by means of a second swivel attachment 23 allowing the second swiveling part 22 to pivot around a second swivel axis 24 that runs outside the circumference 17 of the saw blade 2. The second swiveling part 22 comprises a slot 47 that admits clearance for the saw blade 2.

Both swiveling parts 18, 22 have a pie-shaped appearance, where the first swiveling part 18 partly extends inside the shielding cover 8, and where the second swiveling part 22 extends inside the first swiveling part 18, such that each swiveling part 18, 22 has a certain degree of exposure that changes as each swiveling part 18, 22 pivot around its corresponding swivel axis 21, 24. As a result of this the first swiveling part 18 has first clearance angle φ and the second swiveling part 22 has second clearance angle θ.

Both swiveling parts 18, 22 self-adjust to the work surface 19 such that the amount of dust that escapes the dust channel 11 in the shielding cover 8 is minimized, resulting in a minimized amount of dust that is released into surrounding air.

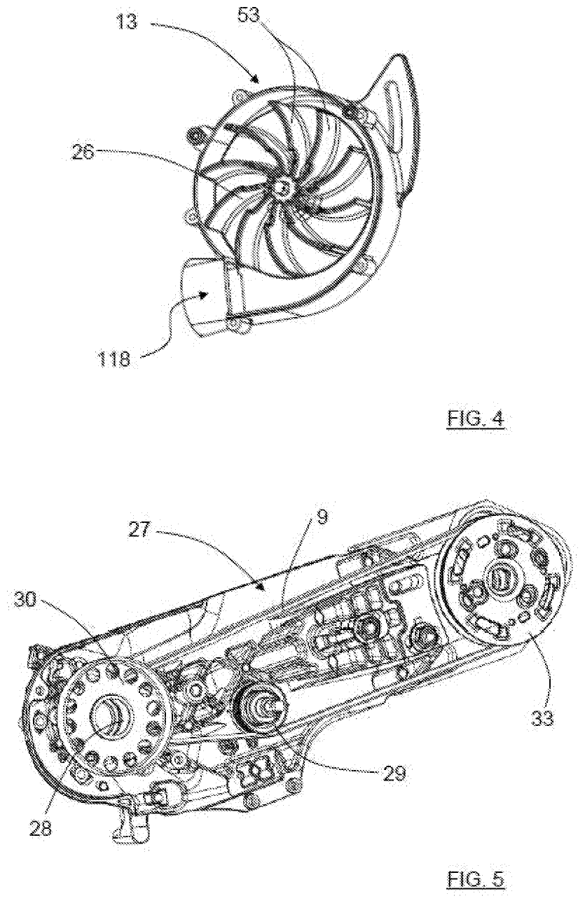

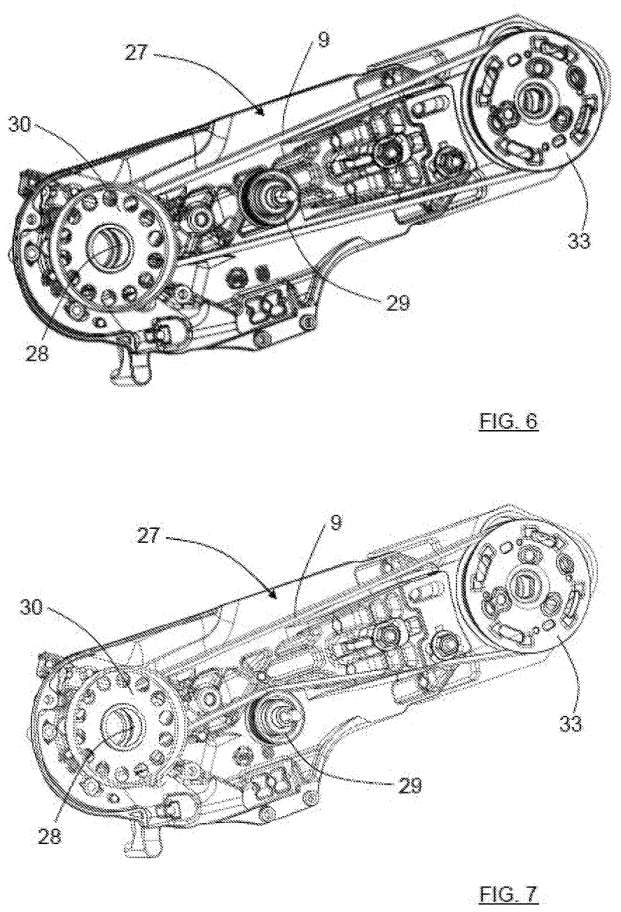

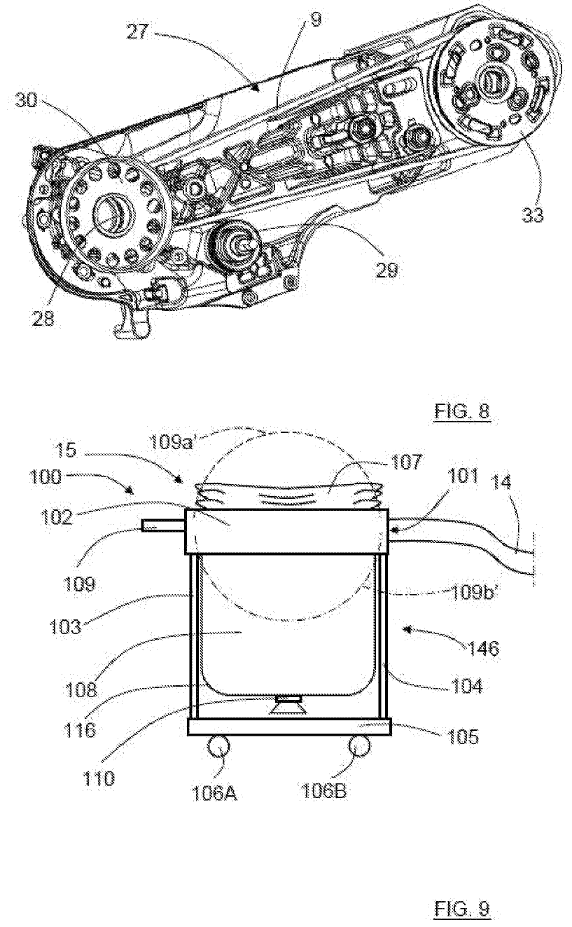

FIG. 3 shows the fan arrangement 13 with a cover 25, and FIG. 4 shows the fan arrangement 13 without the cover 25, where a fan turbine 26 is placed and arranged to be propelled for conveying dust from the dust pipe 12 and further into the hose 14 as shown in FIG. 1. For this purpose, the fan turbine 26 comprises a plurality of fan blades 53 as shown in FIG. 4.

FIG. 5 and FIG. 6 show respective perspective front views of the power transferring unit 27 of the power cutter where the power transfer cover 10 and the fan arrangement 13 are removed. A first driving pulley 28 is connected to an endless drive belt 9 that here constitutes the power transferring means, where the drive belt is tensioned against a fan pulley 29 that is arranged to be connected to the fan turbine 26 when the fan arrangement 13 is mounted. The fan pulley 29 is furthermore arranged to propel the fan turbine 26 when the drive belt 9 rotates the fan pulley 29. The drive belt 9 is arranged to propel the second driving pulley 33 which is arranged to propel the saw blade 2 in a well-known manner; for example directly or via a transmission.

The first driving pulley 28 is connected to the engine via a clutch wheel 30 and an engine gear arrangement (not shown). For reasons of clarity, well-known clutch parts that normally are positioned within the clutch wheel 30 and are arranged to confer transmission between the clutch wheel 30 and the first driving pulley 28 at certain rotational velocities are not shown. These clutch parts normally work by centrifugal forces and are commonly used in tools of this kind. The clutch wheel 30 and the first driving pulley 28 are arranged to rotate around a common driving axis.

According to some aspects, the rotational speed of the engine is geared to a lower rotational speed at the first driving pulley 28 by means of the engine gear arrangement, and then the rotational speed of the a second driving pulley 33 is geared to a lower rotational speed at the saw blade 2.

This means that during operation of the power cutter 1, the engine 4 is arranged to propel the first driving pulley 28 via the clutch wheel 30, where the first driving pulley 28 in turn drives the drive belt 9. When the drive belt is moving, it also rotates the fan pulley 29, bringing the fan turbine 26 into motion and thus the fan arrangement 13 into operation. By choosing a suitable diameter of the fan pulley 29, a desired rotational speed of the fan pulley 29, and thus of the fan turbine 26, during normal operation of the power cutter 1 is obtained.

Furthermore, according to yet another aspect of the present disclosure, the fan pulley 29 is adjustable and arranged for tensioning the drive belt 9. In FIG. 5, the fan pulley 29 is adjusted such that the drive belt 9 is tensioned and ready for operation, and in FIG. 6, the fan pulley 29 is adjusted such that the drive belt 9 is released from tension, a suitable position if, for example, the drive belt should be replaced. Here, the drive belt 9 is running on an outside of the fan pulley 29, such that when the fan pulley 29 is moved away from a part of the drive belt 9 that is extending between the first driving pulley 28 and the saw blade, and is not intended to be in contact with the fan pulley 29, the drive belt 9 is tensioned.

The drive belt 9 could run at any side of the fan pulley 29, as shown in FIG. 7 and FIG. 8. In FIG. 7, the fan pulley 29 is adjusted such that the drive belt 9 is tensioned and ready for operation, and in FIG. 8, the fan pulley 29 is adjusted such that the drive belt 9 is released from tension. Here, the drive belt 9 is running on an inside of the fan pulley 29, such that when the fan pulley 29 is moved away from a part of the drive belt 9 that is extending between the first driving pulley 28 and the saw blade, and is not intended to be in contact with the fan pulley 29, the drive belt 9 is released from tension.

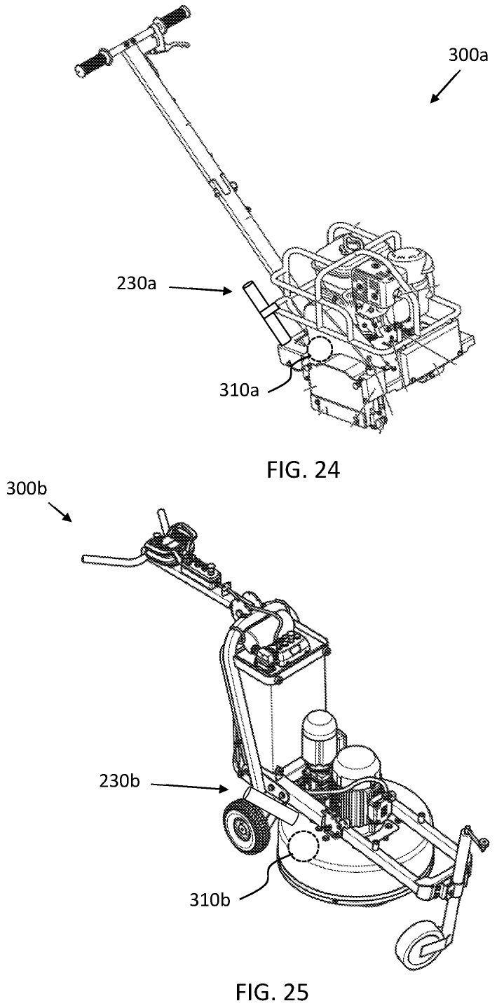

The dust container arrangement 15 will now be described more in detail with reference to FIG. 9-11. The dust container arrangements discussed herein may be used with the power cutter discussed in connection to FIG. 1, and also with other types of construction equipment, such as the early entry floor saws, floor saws, and floor grinding machines discussed below in connection to, e.g., FIGS. 24-30.

The dust container arrangement 15 comprises a frame 100 which in turn comprises a holder part 102, supporting means 103, 104, a base part 105 and wheels 106A, 106B that are attached to the base part 105, where the holder part 102 comprises a container inlet 101 and a handle 109.

The dust container arrangement 15 comprises a first bag or container 107, shown collapsed in FIG. 9 and FIG. 11, and a second bag or container 108 that is adapted to receive dust that is brought into the container inlet 101. Both bags 107, 108 are releasably attached to opposite sides of the holder part 102 in a sealed manner. The first bag 107 is air-permeable such that air that is blown into the container inlet 101 is permitted to escape through a wall 115 of the first bag 107, while the second bag 108 is air-tight, and its wall 116 is according to some aspects made in plastic. This means that the second bag 108 constitutes a barrier towards the ambient atmospheric pressure during operation.

The holder part 102 is attached to the base part 105 via the supporting means 103, 104, where the second bag 108 is adapted to run between the holder part 102 and the base part 105. According to some aspects, the second bag 108 is comprised in an elongated rolled-up or folded plastic tube 111 that gradually is manually unrolled or unfolded when one second bag 108 is to be changed. Each second bag 108 is closed at its bottom with a bottom sealing clamp 110 or strip of a suitable type.

As shown in FIG. 10, air, and dust 113A is blown into the container inlet 101 from a dust hose 14, suitably by means of a fan arrangement 13 as previously described, where the air is illustrated with a first arrow A1. The first bag 107 is expanded by means of the increased air pressure inflicted in a volume V that advantageously is formed in the first bag 107, inside the holder part 102 and the second bag 108. The air is mainly blowing towards the first bag 107 since it is air-permeable as indicated with a second arrow A2. The air that escapes the volume V through the air-permeable fabric of the first bag 107 is indicated with third arrows A3. The dust 113A that is blown into the volume V via the container inlet 101 will fall downwards as falling dust 1138 towards the second bag 108 and its bottom where a dust pile 113C is forming.

This means that the air A1 and the dust 113A blown into the container inlet 101 is separated where the dust falls to the dust pile 113C and the air flows towards and through the air-permeable fabric of the first bag 107.

A change of second bag 108 is illustrated in FIG. 11, where a full second bag 108 has been cut from the plastic tube 111 and sealed at its upper end with top sealing clamp 112 or strip of a suitable type. The shown part of the plastic tube 111 is pulled towards the base part 105 and then sealed with a new bottom sealing clamp 110 or strip of a suitable type such that the configuration according to FIG. 9 is again obtained. In order to avoid dust spilling out from the plastic tube 111 the top sealing clamp 112 and a new bottom sealing clamp can be applied before the full second bag 108 is cut from the plastic tube 111, where the cut is made between the top sealing clamp 112 and the new bottom sealing clamp.

The second bag 108 is air-tight at least during operation, with bottom sealing clamp 110 in place. In the context, the term airtight is not to be interpreted as totally air-tight, but air-tight within what is practically obtainable in this field of technology.

The sealing clamps 110, 112 are generally constituted by sealing means that can be constituted by cable ties.

In accordance with the present disclosure, the second bag 108 is easily changed and efficiently sealed such that fine dust is prevented from being accidentally released from the second bag 108 when it is replaced with a new one. Having a plastic second bag furthermore makes it very inexpensive, especially when a plastic tube 111 according to the above is used. Furthermore, the first bag 107 also constitutes a filter medium since the air A1 that is blown into the volume V escapes via the air-permeable wall of the first bag, resulting in not needing to change a special filter. Furthermore, due to the working of the dust container arrangement 15 with most of the dust falling into the second bag 108, the first bag 107 seldom needs to be changed.

In this context, it is desired that the air flow A1 though the dust hose 14 into the volume V via the container inlet 101 is sufficient for expanding the first bag 107 and for blowing the dust 113A into the volume V, and is dependent both on the blowing power of the fan arrangement 13 and the amount of air A3 that escapes the volume V per time unit.

As described, the blowing power of the fan arrangement 13 is dependent of motor speed of the construction equipment, and this means that the more the construction equipment is powered, the more the air flow is increased. It can be supposed that an increase of power to, e.g., a power cutter relates to an increased amount of created dust, which will be handled by the increased air flow. During use, according to some aspects at a maximum speed, the air pressure at the container inlet 101 exceeds the ambient atmospheric pressure with less than 0.05 Bar, preferably with less than 0.03 Bar, more preferably with less than 0.01 Bar. According to some aspects, the air pressure at the container inlet during operation exceeds the ambient atmospheric pressure with less than 0.005 Bar.

According to some aspects, the fan arrangement 13 is adapted to establish a maximum air flow through the hose 14, corresponding to the air A1 that is blown into the container inlet 101, that lies between 30 l/s and 80 l/s, preferably between 40 l/s and 70 l/s, and most preferably between 50 l/s and 60 l/s.

According to some aspects, a maximum air pressure at the container inlet 101 exceeds the ambient atmospheric pressure with less than 0.1 Bar, preferably with less than 0.07 Bar, and even more preferably with less than 0.05 Bar. Such a maximum air pressure is obtained when the container inlet 101 is blocked, or when no air can escape the volume V, and at a maximum speed.

Furthermore, the amount of air A3 that escapes the volume V per time unit is dependent on the area of the wall 115 of first bag 107, and the wall's air-permeable characteristics. According to some aspects, the area of the wall 115 of first bag 107 is about 1.5-2.5 m². According to some further aspects, the wall 115 of first bag 107 is a material with classification HEPA or HEPA H13. Generally the permeable characteristics of the wall 115 should be such that there is a filtering degree of at least 99.997% for all particles having a size of, or exceeding, 0.3 μm. According to some further aspects, the filtering degree is preferably at least 99.99% for all particles having a size of, or exceeding, 0.3 μm, and according to some further aspects, the filtering degree is at least 99.97% for all particles having a size of, or exceeding, 0.3 μm. The filtering degree is applicable for the air flows mentioned above.

According to some aspects, all figures regarding air flow and pressure are applicable for a either normal running or, according to some further aspects, to a running that is limited by the maximum rotational speed for the fan turbine 26 irrespective of it is driven by the drive belt or by a separate fan motor as will be described later.

Furthermore, the cross-sectional area of the second bag 107, the cross-sectional area of the hose 14, and their relation, also affect the functional properties of the dust container arrangement 15. According to some aspects, the relationship between the cross-sectional area of the first bag 107 and the cross-sectional area of the hose 14 is in a magnitude between 5 and 7.

Having an air pressure in the volume V that exceeds the atmospheric pressure keeps the first bag 107 expanded as well, while in some prior dust containers there is an air pressure during use in the dust container that falls below the atmospheric pressure, such that a dust bag normally used has to be physically retained in its proper place, the dust bag being sucked towards a dust hose.

According to some aspects, the air pressure at the container inlet 101 should be adapted such that the first bag 107 is kept expanded during operation in view of the air-permeable characteristics of the wall 115 of the first bag 107. In the case of the second bag 108 being comprised in an elongated rolled-up or folded plastic tube 111, the air pressure at the container inlet 101 should be adapted such that the plastic tube 111 is not unrolled or unfolded in an undesired manner during operation.

According to some aspects, when not in use, the first bag 107 is depressed and stored in the holder part 102.

In FIG. 10, a one-way valve 117 is schematically indicated in an open state at the container inlet 101. When the air flow A1 is terminated, the first bag 107 will more or less fall into a collapsed state as shown in FIG. 9 and FIG. 11, and then the one-way valve 117 will close, preventing dust in the volume V from entering the hose 14. In the collapsed state, the first bag 107 will require very little space, and can according to some aspects be more or less be placed within a confinement of the holder part 102. This makes transport of the dust container arrangement 15 very easy.

A more detailed view of an example of a one-way valve is discussed later for an alternative dust container arrangement described below.

FIG. 12 shows an operator 114 that easily carries both the dust container arrangement 15 and a power cutter 1, illustrating a versatile tool system 119 comprising a power cutter 1 with an integrated fan arrangement 13 and the passive dust container arrangement 15. The dust container arrangement 15 can easily be carried or rolled on its wheels 106A, 106B.

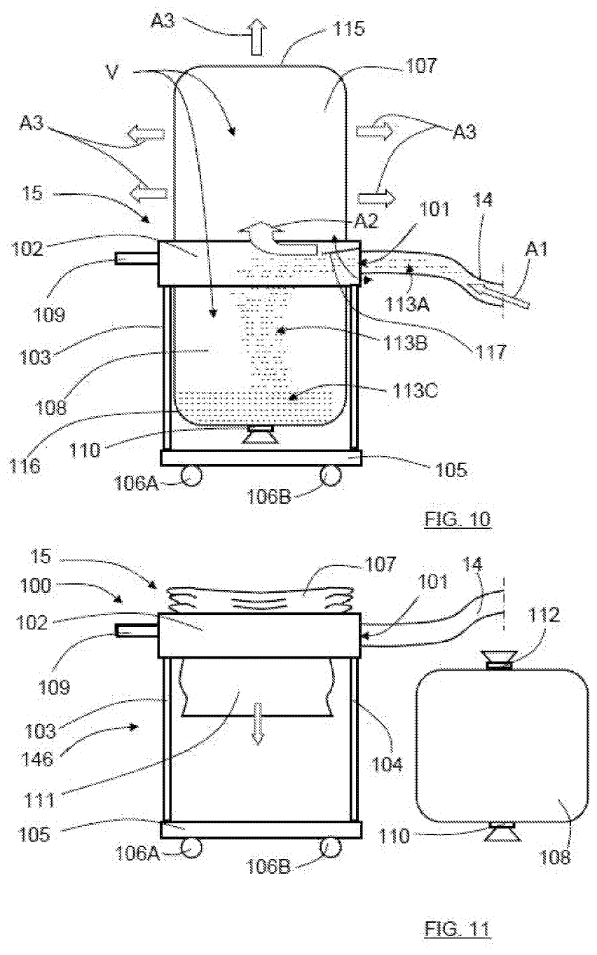

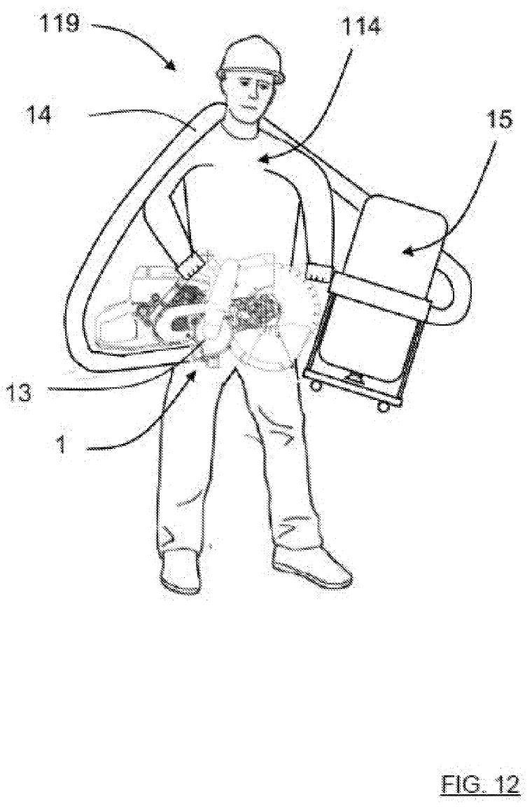

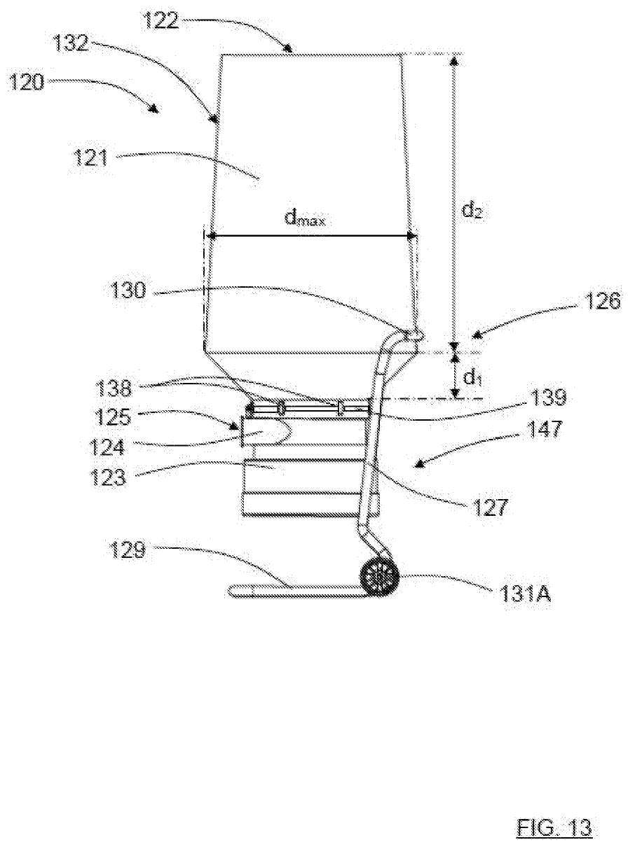

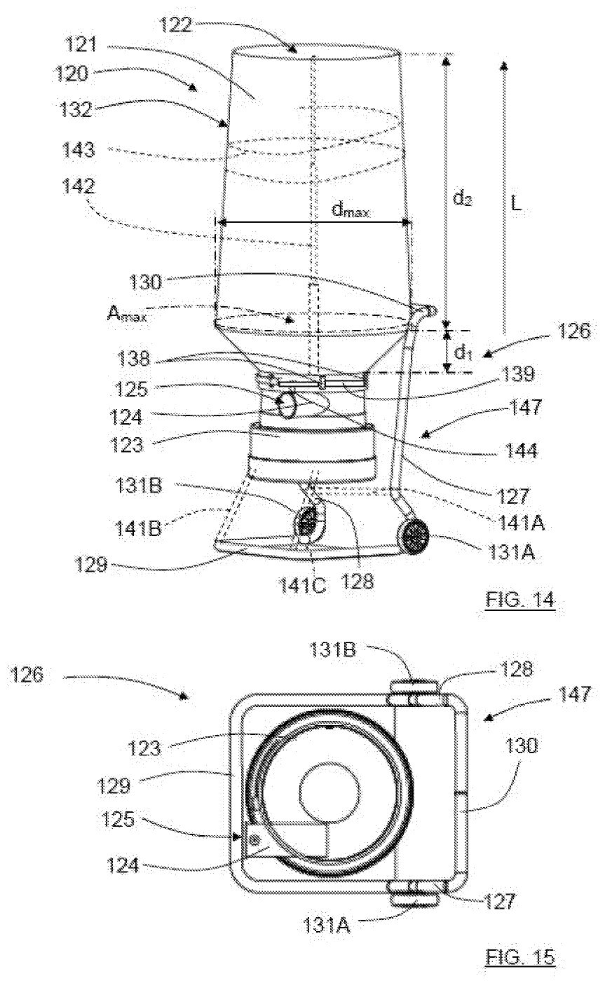

An alternative dust container arrangement 120 is shown in FIG. 13 and FIG. 14; here the second bag and the hose are not shown but can of course be of the types previously described. According to some aspects, the first bag 121 has a shape where a largest diameter dₘₐₓ is present at a first distance d₁ from the holder part 123 and a second distance d₂ from a top 122 of the first bag 121 along a longitudinal extension L, the top 122 being a part of the first bag 121 being positioned farthest away from the holder part 123 along the longitudinal extension. The first distance d₁ falls below second distance dz. The largest diameter dₘₐₓ exceeds the diameter of the holding part 123. Having such a configuration, the first bag 121 is more easily expanded when commencing operation.

According to some aspects, the sum of the first distance d₁ and the second distance d₂, a height of the first bag 121, is between 70 cm and 110 cm, and the largest diameter dₘₐₓ is between 40 cm and 60 cm.

Generally, the first bag 121 has a shape where a largest cross-sectional area Amax in a plane perpendicular to a longitudinal extension L is present at a first distance d₁ from the holder part 123 and a second distance d₂ from the top 122 of the first bag 121 along the longitudinal extension L, the top 122 being a part of the first bag 121 being positioned farthest away from the holder part 123 along the longitudinal extension. The first distance d₁ falls below second distance dz. The largest diameter dₘₐₓ exceeds the diameter of the holding part 123. According to some aspects, the largest cross-sectional area Amax is exceeding a cross-sectional area of the holding part 123 in a plane perpendicular to the longitudinal extension L.

The above generalization takes different cross-sectional shapes into account.

Generally, according to some aspects, the largest cross-sectional area Amax is between 0.5 m² and 1.1 m².

With reference also to FIG. 15 that shows a top view of the dust container arrangement 120 without any bags, the holder part 123 comprises a hose holder tube 124 that in turn comprises the container inlet 125. The dust container arrangement 120 comprises a frame 126 which in turn comprises the holder part 123, supporting means 127, 128, a base part 129, a handle 130 and two wheels 131A, 131B that are attached to the base part 129.

According to some aspects, as illustrated schematically with dotted lines in FIG. 14, the frame 126 comprises further one or more supporting means 141A, 141B, 141C that are intended to retain the second bag when mounted. By retaining the second bag, its possible movements are restricted such that it is prevented from getting in an undesired position, in particular in a tilted position.

When standing in a working position, the dust container arrangement 120 at least mainly rests on the base part 129. The wheels 131A, 131 either are in contact with the ground or not. When the dust container arrangement 120 is to be moved, it is gripped by the handle 129 and tilted around the wheels 131A, 131 such that the base part 129 is lifted from the ground and the dust container arrangement 120 only rests on the wheels 131A, 131.

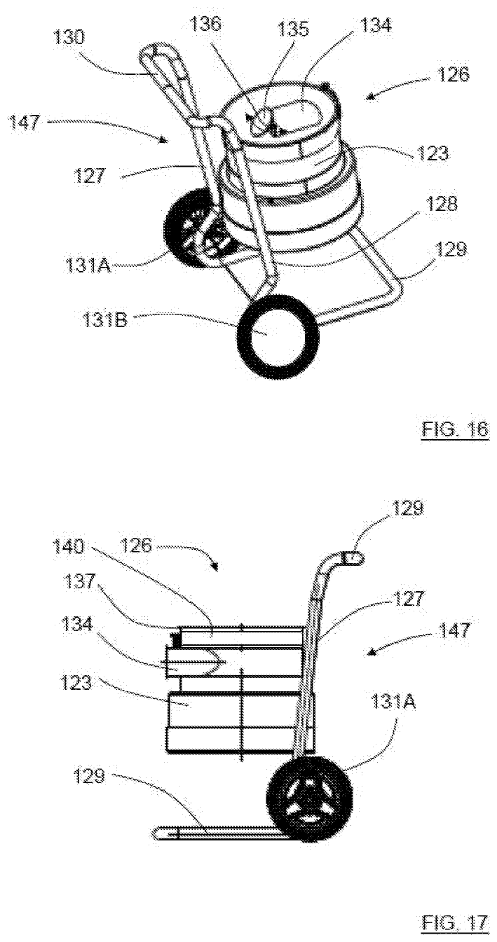

FIG. 16 shows a top perspective view of the frame 126 without any bags, here a one-way valve 134 is shown at an inner end of the hose holder tube 124. According to some aspects, the one-way valve 134 comprises a movable flap part 135 that is pivotably arranged at an upper part of an inner opening 136 of the hose holder tube 124 and can for example be made in plastic or rubber. The flap part 135 is shown in an open position in FIG. 16, being opened due to air flowing through the hose holder tube 124 into the holder part 123. When such an air flow is discontinued, or at least lowered to a certain degree, the flap part 135 will fall against the inner opening 136 of the hose holder tube 124 and providing a certain degree of sealing of that inner opening 136, thus preventing dust in the dust container arrangement 120 to escape backwards when the operation of the fan arrangement 13 is discontinued.

According to some aspects, the inner opening 136 of the hose holder tube 124 is wedge-shaped such that a lower part of the hose holder tube 124 protrudes farther into the holder part 123 than an upper part, the flap part being pivotably arranged at the upper part. In this manner, a more reliable sealing is accomplished when the operation of the fan arrangement 13 is discontinued. The flap part 135 is thus kept in a closed position at least by means of the gravity force when the operation of the fan arrangement 13 has been discontinued. The fan arrangement 13 has to provide an air flow that is sufficiently strong to move the flap part 135 and open the one-way valve 134, overcoming said gravity force.

FIG. 17 shows a side view of the frame 126 without any bags. Here, it is shown that the holder part 123 comprises a top flange 137 that is adapted to face the first bag. With reference also to FIG. 13, where the first bag 121 is mounted, the first bag 121 comprises a plurality of loops 138, see FIG. 14, through which a strap 139 is intended to run in a circumferential manner. By tightening the strap 139 the first bag is fastened and held between the strap 139 and the holder part 123, where the strap 139 will not be able to escape over the top flange 137, and since it is fastened in the loops 138, the first bag 121 will not escape over the top flange 137 either. In this manner, the first bag 121 is securely attached to the holder part 123. The strap 139 can be made in any suitable material that according to some aspects can be resilient. The strap 139 can according to some aspects comprise tightening means such as a buckle.

According to some aspects, as shown in FIG. 17, the holder part 123 comprises a circumferentially running layer of resilient material 140 such as a foam layer, against which the strap 139 can be tightened and which further prevents movement of the first bag 121. This means that when the strap 139 is tightened, the first bag 121 is fastened and held between the strap 139 and the resilient material 140.

In all cases, when the strap 139 is tightened, is runs circumferentially, encompassing the first bag 121, the holder part 123, and, if present, the resilient material 140.

According to some aspects, as indicated in FIG. 14, the hose holder tube 124 comprises a locking pin 144 which is intended for locking the hose to, and releasing the hose from, the hose holder tube 124.

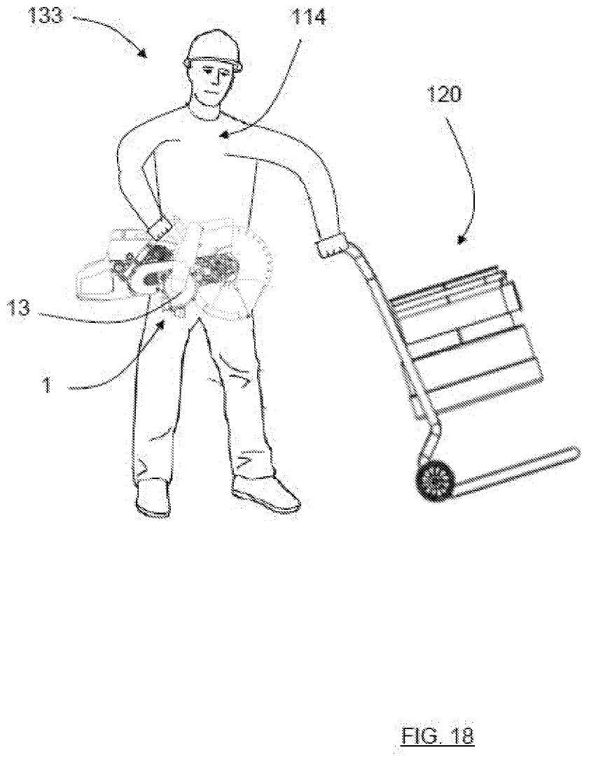

FIG. 18 shows an operator 114 that easily carries the power cutter 1 and can move the dust container arrangement 120 as it rolls on its wheels, illustrating a versatile tool system 133 comprising a power cutter 1 with an integrated fan arrangement 13 and the passive dust container arrangement 120. Here, the first bag 121 is stored in the holder part 123 and the second bag has been removed.

The present disclosure is not limited to the above examples but may vary freely within the scope of the appended claims. For example, the dust container arrangement 15 has been described for use with a hand-held power cutter 1 with a ring-shaped saw blade 2, but the power cutter may be any type of power tool with a work tool such as a circular saw blade, a circular saw blade or a ring saw blade, where dust removal is desired. The dust container arrangements may also be used with other types of construction equipment. The construction equipment can have an engine that either is a combustion engine or an electric motor that can be adapted for either battery power to an electric mains supply. In the case of a combustion engine, the engine is according to some aspects constituted by a two stroke combustion engine, but four-stroke engines are also applicable in some cases.

The construction equipment is according to some aspects portable and/or hand-held and is according to some further aspects equipped with wheels for facilitated handling. As will be discussed in more detail below, the dust container arrangements may also be used with self-propelled or pushable machines for surface treatment, such as floor saws, early entry floor saws, floor grinders, and floor polishing machines.

Some versions of the dust container arrangements 15, 120 are arranged to be fixedly or releasably mounted directly onto construction equipment. Such mountable versions 210 may be identical to the dust container arrangements 15, 120 discussed above, or may comprise a subset of the features discussed above. Notably, a dust container arrangement arranged to be mounted directly onto construction equipment may still comprise a mobility assembly with wheels, in order to allow use of the dust container arrangement both in mounted configurations where it is supported by the construction equipment, and in self-supported configurations where the dust container arrangement supports itself on the ground by, e.g., a mobility assembly.

With reference to FIG. 19, in the case of a power tool 1′ adapted for battery power, a fan arrangement 13′ that is arranged to convey air towards the dust container arrangement comprises an electric motor 148 that is powered by means of a battery 145. The same battery 145 can also be used for powering the power tool 1′, the power tool then comprising a further electric motor 149 that is adapted to propel a work tool 2.

In all cases, the dust container arrangement 15 is adapted to be fluidly coupled to construction equipment which comprises an integrated fan arrangement 13 that is propelled by means of the construction equipment engine, either directly such as described by means of a fan pulley 29, or indirectly where the fan is electrically powered, according to some aspects by an electrical current that is generated in the construction equipment.

When a fan pulley is used, being propelled by means of a power transferring means that is driven by an engine, such a fan pulley can be used for tensioning the power transferring means as previously described. Other tensioning arrangements can also be comprised in, e.g., a power cutter and used instead of the fan pulley or in combination with the fan pulley. Notably, the power transferring means may be comprised in a power cutter such as that discussed in connection to FIG. 1, or some other type of construction equipment, such as the machines 300, 300a, 300b, 300v discussed below in connection to FIGS. 20-30.

When a drive belt 9 is used, according to some aspects the drive belt is arranged to propel the saw blade via a gear transmission.

According to some aspects, the dust container arrangement 15, 120 comprises a supporting device that is adapted to maintain the first bag 107, 121 in an expanded position. In this manner the first bag 107, 121 is more easily kept clean and dry, and is more quickly put into a working expanded position during use. As schematically indicated with dotted lines in FIG. 14, such a supporting device can according to some aspects be in the form of a telescopic rod 142 that extends within the first bag 107, 121, or in the form of a flexible spiral rod 143 (only a few turns indicated) that extends along the wall 115, 132 of first bag 107, 121. Both these examples of supporting devices admit that the first bag 107, 121 is depressed and stored in the holder part 102, 123 when not in use as mentioned previously.

The dust container arrangement 15, 120 may also be mounted directly onto construction equipment. It is then referred to as dust container arrangement 210, 210a, 210b. This configuration will be discussed in more detail below in connection to FIGS. 27-30.

The dust hose is, according to some aspects, a flexible dust hose 14. The flexible dust hose 14 is adapted for releasable connection to both the container inlet 101 and a fan output 118 as shown in FIG. 1, FIG. 3, and FIG. 4. The length of the flexible dust hose 14 is according to some aspects between 1 m and 10 m; according to some further aspects between 2 m and 4 m. The diameter of the flexible dust hose 14 is according to some aspects between 5 cm and 10 cm.

According to some aspects, the dust hose is an anti-static hose arranged to resist electrical charge, i.e., static, build-up. Such anti-static hoses are known and will therefore not be discussed in more detail herein.

According to some aspects, when not in use, the dust hose 14 can be rolled up and stored in the holder part 102, 123. If the first container or bag 107, 121 is stored in the holder part 102, 123, the dust hose 14 can be put on top of the first bag 107, 121. This is the case in FIG. 16.

The dust container arrangement 15, 120 is adapted to be fluidly coupled to a fan arrangement 13 comprised in a power cutter 1 or construction equipment 300a, 300b, 300c via a flexible dust hose 14. The fan arrangement 13 being comprised in the construction equipment generally means that a first shortest dust travel distance between the fan arrangement 13 and the dust container arrangement 15, 120 exceeds a second shortest dust travel distance between the fan arrangement 13 and a dust channel 11 that is formed between the blade guard 8 and the rotatable work tool 2 such as a saw blade.

The handles 109, 130 shown are fixed handles, but there can be any type of handle that is comprised in a handle arrangement with one or more handles. An alternative handle type is schematically indicated in FIG. 9 and is a pivotable handle 109a′, 109b′ as indicated in an upright holding position 109a′ with dashed lined and in a rested position 109b′ with a dash-dotted line.

The dust hose 14 is generally constituted by an at least partly flexible dust conduit 14. However, rigid tubing may be used in some embodiments, e.g., to connect the dust container arrangement 210 to construction equipment when the dust container arrangement is mounted directly onto the construction equipment.

The first bag 107, 121 and the second bag 108 are generally constituted by a corresponding first container 107, 121 and second container 108. The second container 108 can be of any suitable type, for example of the plastic bag type described previously. According to some aspects, the second container 108 is in the form of a rigid can or bucket that for example is made in rigid plastic or metal. In this case, according to some aspects, the second container 108 comprises a lid that can be slid or put into place before the second container 108 is removed. The second container 108 can be then be emptied and directly re-mounted or replaced with another empty second container.

Expressions such as air-tight should be interpreted to define a property that lies within what is practically obtainable in the present technical field.

Generally, the present disclosure relates to a dust container arrangement 15, 120 adapted to be fluidly coupled to a fan arrangement 13 comprised in a power tool 1 via an at least partly flexible dust conduit 14, where the dust container arrangement 15, 120 comprises a frame 100, 126 which in turn comprises a holder part 102, 123 with a container inlet 101, 125. The dust container arrangement 15, 120 further comprises a first container 107, 121 and a second container 108, which containers 107, 108; 121 are releasably attached to the holder part 102, 123 in a sealed manner. The first container 107, 121 is air-permeable such that air A1 that is blown into the container inlet 101, 125 is permitted to escape through a wall 115 132 of the first container 107, 121, while the second container 108 is air-tight during operation and adapted to receive dust 113A, 1138, 113C that is brought into the container inlet 101, 125.

According to some aspects, in an operating state, the containers 107, 108; 121 are located on opposite sides of the holder part 102, 123.

According to some aspects, the containers 107, 108; 121 are releasably attached to opposite sides of the holder part 102.

According to some aspects, the second container 108 constitutes a barrier towards ambient atmospheric pressure during operation.

According to some aspects, the second container 108 is constituted by a plastic bag and is comprised in an elongated rolled-up or folded plastic tube 111 that gradually is adapted to be unrolled or unfolded when one second container 108 is to be changed, where each second container 108 is closed at its bottom with a bottom sealing means 110.

According to some aspects, when a used second container 108 is to be changed, it is adapted to be closed at its top with a top sealing means 112, and the following new second container is adapted to be closed at its bottom with a new bottom sealing means 110 before the second containers are separated from each other by means of a cut in between the top sealing means 112 and the new bottom sealing clamp.

According to some aspects, the dust container arrangement 15 comprises a one-way valve 117, 134 arranged at the container inlet 101, 125 and being adapted to prevent air and dust to flow from the dust container arrangement 15, 120, in a direction that is opposite the air and dust flow direction during operation, via the container inlet 101, 125.

According to some aspects, the frame 100, 126 further comprises a mobility assembly 146, 147, where the holder part 102, 123 is attached to the mobility assembly 146, 147 by a non-permanent or permanent fastening method.

According to some aspects, the mobility assembly 146, 147 comprises a handle 109, 130 attached to the holder part 102, 123.

According to some aspects, the mobility assembly 146, 147 comprises a frame 100, 126 and wheels 106A, 106B; 131A, 131B.

According to some aspects, the mobility assembly 146, 147 further comprises supporting means 103, 104; 127, 128 and a base part 105, 129, where the wheels 106A, 106B; 131A, 131B are attached to the base part 105, 129, where the holder part 102, 123 is attached to the base part 105, 129 via the supporting means 103, 104; 127, 128.

According to some aspects, the second container 108 is adapted to run between the holder part 102, 123 and the base part 105, 129.

According to some aspects, the air pressure at the container inlet 101, 125 during operation exceeds the ambient atmospheric pressure with less than 0.05 Bar, preferably with less than 0.03 Bar, more preferably with less than 0.01 Bar, and even more preferably with less than 0.005 Bar.

According to some aspects, a maximum air pressure at the container inlet 101, 125 exceeds the ambient atmospheric pressure with less than 0.1 Bar, preferably with less than 0.07 Bar, and even more preferably with less than 0.05 Bar.

According to some aspects, the dust container arrangement 15, 120 is adapted to be fluidly coupled to a fan arrangement 13 that is arranged to convey air towards the dust container arrangement 15, 120 and comprises a fan turbine 26 that is connected to a fan pulley 29, where a drive belt 9 comprised in the power tool is arranged to propel the fan pulley 29.

According to some aspects, the dust container arrangement 15, 120 is adapted to be fluidly coupled to a fan arrangement 13′ that is arranged to convey air towards the dust container arrangement 15, 120, where the fan arrangement 13′ comprises an electric motor 148 that is powered by means of a battery 145.

According to some aspects, in an idle state, the first container 107, 121 is adapted to be depressed and stored in the holder part 102, 123.

According to some aspects, the wall 115, 132 of first container 107, 121 is made in a material with permeable characteristics that, at a maximum air flow for air A1 that is blown into the container inlet 101, provides a filtering degree of one of: at least 99.997% for all particles having a size of, or exceeding, 0.3 μm, at least 99.99% for all particles having a size of, or exceeding, 0.3 μm, or at least 99.97% for all particles having a size of, or exceeding, 0.3 μm.

According to some aspects, the maximum air flow for air A1 that is blown into the container inlet 101 lies between 30 l/s and 80 l/s, preferably between 40 l/s and 70 l/s, and most preferably between 50 l/s and 60 l/s.

According to some aspects, the first container 121 has a shape where a largest cross-sectional area Amax in a plane perpendicular to a longitudinal extension L is present at a first distance d₁ from the holder part 123 and a second distance d₂ from a top 122 of the first container 121, the top 122 being a part of the first container 121 adapted to be positioned farthest away from the holder part 123, where the first distance d₁ falls below second distance dz.

According to some aspects, the largest cross-sectional area Amax exceeds a cross-sectional area of the holding part 123 in a plane perpendicular to the longitudinal extension L.

According to some aspects, the dust container arrangement 15, 120 comprises a supporting device 142, 143 that is adapted to maintain the first container 121 in a more or less expanded position.

According to some aspects, the supporting device either is in the form of a telescopic rod 142 that extends within the first container 107, 121, or in the form of a flexible spiral rod 143 that extends along the wall 115, 132 of first container 107, 121.

The present disclosure also generally relates to a tool system 119, 133 comprising a power tool 1 that in turn comprises a fan arrangement 13 adapted to transport dust, where the tool system 119, 133 further comprises a dust container arrangement 15, 120 according to the above. The fan arrangement 13 is arranged to be fluidly coupled between a dust channel 11 on the power tool 1 and the container inlet 101 of the dust container arrangement 15, 120 by means of a dust conduit 14.

According to some aspects, the power tool 1 is adapted to propel a work tool 2, where the fan arrangement 13 is propelled by the same power source as the work tool 2.

According to some aspects, the power tool 1 is a hand-held power tool.

According to some aspects, the power tool 1 is power cutter.

According to some aspects, the power tool 1 and the fan arrangement 13 are physically connected at least during operation.

According to some aspects, the power tool 1′ is battery-powered and comprises a rotatable work tool 2 and a battery 145, where the dust container arrangement 15, 120 is adapted to be fluidly coupled to a fan arrangement 13′ that is arranged to convey air towards the dust container arrangement 15, 120, where the fan arrangement 13′ comprises an electric motor 148 that is powered by means of the battery 145.

According to some aspects, the power tool 1 comprises a rotatable work tool 2 and an engine 4 that is arranged to propel a first driving pulley 28 comprised in a power transferring unit 27, where the power transferring unit 27 comprises an endless drive belt 9 that is arranged to at least indirectly propel the rotatable work tool 2 when the first driving pulley 28 is propelled. The power tool 1 further comprises a blade guard 8 that is arranged to shield a part of the rotatable work tool 2, and a dust channel 11 that is formed between the blade guard 8 and the rotatable work tool 2, which dust channel 11 is fluidly coupled to a fan arrangement 13. The fan arrangement 13 is arranged to convey air from the dust channel 11 and comprises a fan turbine 26 that is connected to a fan pulley 29 comprised in the power transferring unit 27, where the drive belt 9 is arranged to propel the fan pulley 29. The tool system further comprises a dust hose 14 that constitutes the dust conduit and is adapted to connect the fan arrangement 13 to the dust container arrangement 15, 120, where the fan arrangement 13 is arranged to convey air from the dust channel 11 towards the dust container arrangement 15, 120 via the dust hose 14.

According to some aspects, when the fan pulley 29 is in a tensioned state, the drive belt 9 is tensioned and arranged to drive both the fan pulley 29 and the rotatable work tool 2, and when the fan pulley 29 is in a released state, the tension of the drive belt 9 is released.

According to some aspects, a first shortest dust travel distance between the fan arrangement 13, 13′ and the dust container arrangement 15, 120 exceeds a second shortest dust travel distance between the fan arrangement 13, 13′ and the dust channel 11 that is formed between a blade guard 8 and the rotatable work tool 2.

According to some aspects, a dust pipe 12 is connected between an upper part of the blade guard 8 and the fan arrangement 13, where the dust pipe 12 is rigid, and where the dust conduit 14 at least partly is flexible.

As noted above, the dust container arrangements 15, 120, 210 discussed herein may also be used together with other types of construction equipment. For instance, the dust container arrangements may be advantageously used together with early entry concrete saws, floor saws, and floor grinders, as will now be discussed. These machines comprise engines which can be used to power fans integrated in the machines, e.g., by belt and pulley systems such as that discussed above in connection to FIGS. 5-8.

A dust container arrangement 15, 120 may be arranged on wheels to be towed behind an early entry concrete saw, a floor saw, or a floor grinder. Alternatively, the dust container arrangement 210 may be mounted directly onto the construction equipment. Notably, a dust container arrangement mounted directly onto construction equipment may still comprise the mobility assembly with wheels discussed above. This provides for a versatile dust container assembly which can be mounted directly onto construction equipment or which can be towed after the construction equipment.

A bracket or hook and a strap can be used to mount the dust container arrangement 210 fixedly or releasably onto construction equipment.

FIG. 20 schematically illustrates an example dust container arrangement 15, 210 similar to the dust container arrangement 15 discussed in connection to FIGS. 9-11 above. However, this dust container arrangement comprises a more sturdy base part 200 arranged to be towed after a piece of construction equipment by a drawbar arrangement 202 similar to a trailer hitch arrangement. This base part 200 comprises a first and a second pair of wheels 201a, 201b. These wheels are of larger diameter D compared to the wheels 106A, 106B discussed above in connection to, e.g., FIG. 9. According to an example, this diameter is on the order of 5-40 cm and preferably about 10 cm, although wider wheels, e.g., on the order of 30 cm may be used.

FIG. 21 illustrates one of these wheels 201a, 201b in detail. The wheel has a width W on the order of 5-15 cm, and preferably about 7 cm. The wheel may optionally also be coated in a resilient material, such as rubber. The width W, the diameter D, and the optional resilient coating on the wheel are properties which contribute to making the wheel suitable for softer concrete, i.e., concrete surfaces which have not yet cured fully. The type of wheel 201a, 201b illustrated in FIG. 21 is often used on so-called Soff-Cut floor saws, also known as early entry floor saws. An early entry floor saw is illustrated in FIG. 24.

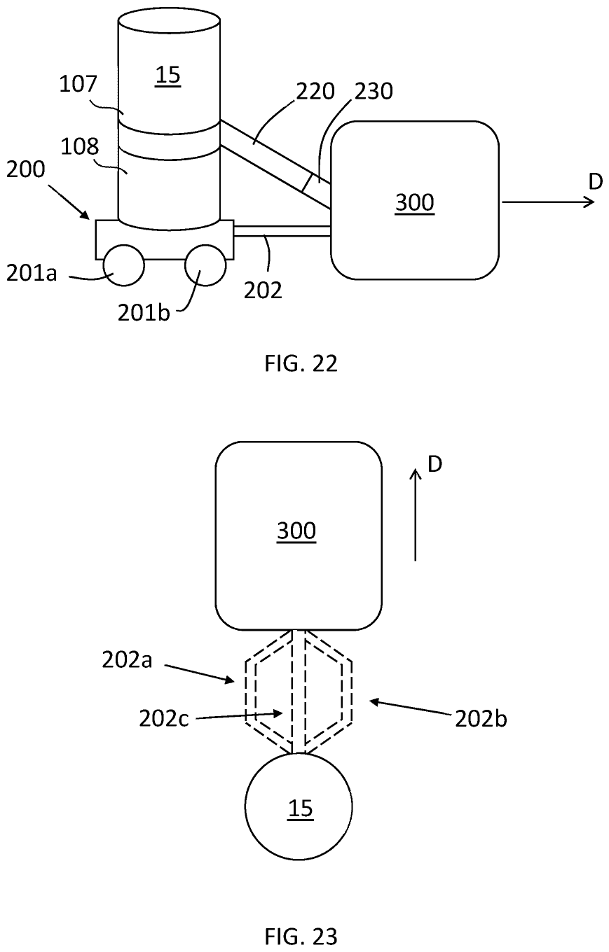

FIG. 22 illustrates a side view of the dust container arrangement 15 being towed in direction D by construction equipment 300, such as a floor saw or a floor grinder. This piece of construction equipment 300 comprises a fan similar to that discussed above. The fan is powered by a power source on the construction equipment. The construction equipment 300 has an outlet 230 in fluid connection to a fan output of the equipment. A hose or tube 220 connected the outlet 230 to the dust container arrangement 15. FIG. 23 shows a top view of the dust container arrangement 15 being towed in direction D by construction equipment 300. Three options for the drawbar arrangement 202 are shown 202a, 202b, 202c.

Notably, the towing or drawbar arrangement 202 may have an arcuate form 202a, 202b in order to allow an operator to walk behind the construction equipment 300, perhaps to push or guide the construction equipment during operation.

FIG. 24 illustrates an early entry floor saw, which is a piece of construction equipment 300a. Early entry concrete sawing relates to the technique of cutting shallow cuts in concrete surfaces within the first one or two hours after finishing surface preparation, i.e., before the concrete has set, a period often referred to as the ‘green zone’. The shallow cuts create a weakened surface plane, thus encouraging cracking to occur at the location of the cuts in a controlled manner rather than the cracks appearing anywhere in the concrete, resulting in a more visually appealing surface. One example of early entry concrete saws is the Soff-Cut range of early entry concrete saw products manufactured by Husqvarna AB.

Early entry concrete sawing machines have been known for some time. Smaller models are often manually operated by means of a handle which an operator uses to guide and push the machine during operation. Larger models are normally self-propelled.

The early entry floor saw 300a comprises an integrated fan 310a (only schematically indicated in FIG. 24). This fan drives the dust towards the dust container arrangement 15.

The early entry floor saw 300a comprises an outlet 230a where a dust container arrangement 15 may be connected. The early entry floor saw 300a also comprises means for towing the dust container arrangement 15, i.e., a mechanism for releasably holding the drawbar in order to tow the base part of the dust container arrangement 15.

FIG. 25 illustrates another example piece of construction equipment—a floor grinder 300b. Similar to the early entry floor saw shown in FIG. 24, the floor grinder comprises an outlet 230b for connecting the dust container arrangement 15 and also means for towing the dust container arrangement 15. The floor grinder 25 also comprises an integrated fan 310b (only schematically indicated in FIG. 25). This fan drives the dust towards the dust container arrangement 15.

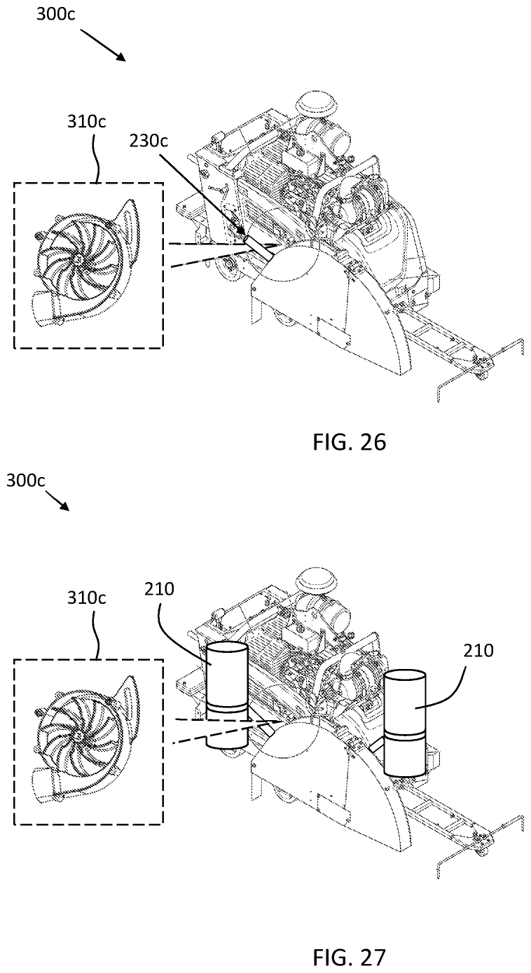

FIG. 26 illustrates yet another example piece of construction equipment—a floor saw 300c. The floor saw comprises an outlet 230c for connecting the dust container arrangement 15 as well as means for towing the dust container arrangement 15. FIG. 26 also shows an example fan 310c which is integrated with the construction equipment 300c.

The various dust container arrangements 210 may, as noted above, also be configured for mounting directly onto a piece of construction equipment. FIGS. 27-30 illustrate examples of this type of arrangement. FIG. 27 shows a dust container arrangement 210 integrated with a floor saw 300c. Two possible locations of the dust container arrangement 210 is shown, but other positions on the construction equipment may also be considered.

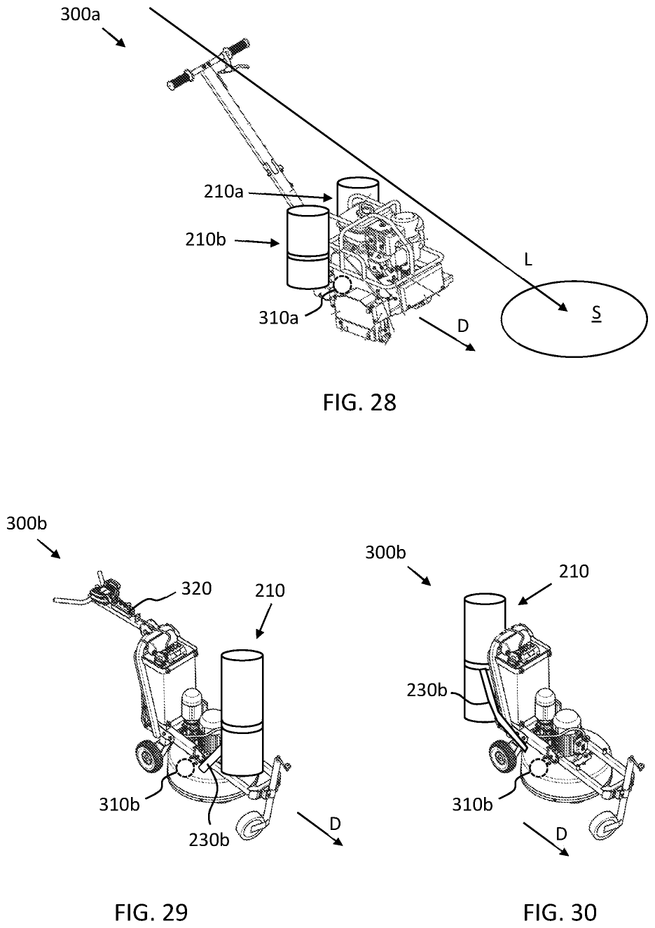

FIG. 28 shows a dual dust container arrangement 210a, 210b arranged on either side of an early entry floor saw 300a. By using two dust container arrangements 210a, 210b, fed by a Y-shaped tube or the like from a single fan, or by two tubes from two fans, a clear line of sight L for an operator of the machine towards a section of floor surface S in front of the construction equipment 300a is obtained. It is also possible to mount the dust container arrangement on a front or rear section of the early entry floor saw.

Generally, where the construction equipment comprises a circular saw blade arranged for up-cut operation, the dust collector arrangement 210 is preferably arranged to be mounted on a rear section of the construction equipment relative to a main operating direction D.

Generally, where the construction equipment comprises a saw blade arranged for down-cut operation, the dust collector arrangement 210 is preferably arranged to be mounted on a front section of the construction equipment relative to a main operating direction D.

FIGS. 29-30 illustrate dust container arrangements 210 arranged directly on a floor grinder 300b. The dust container arrangement can be mounted on a rear section or on a front section of the machine, relative to an operating direction D of the machine. The floor grinder in FIG. 30 is a remote controlled machine without handle 320. In this case it may be advantageous to select the rearward placement of the dust container arrangement.

1. A dust container arrangement adapted to be fluidly coupled to a fan arrangement comprised in construction equipment via a dust conduit, wherein the dust container arrangement comprises a frame which in turn comprises a holder part with a container inlet, wherein the dust container arrangement further comprises a first container and a second container, the first and second containers being releasably attached to the holder part in a sealed manner, wherein the first container is air-permeable such that air that is blown into the container inlet is permitted to escape through a wall of the first container, and wherein the second container is air-tight during operation and adapted to receive dust that is brought into the container inlet.

2. The dust container arrangement according to claim 1, wherein, in an operating state, the first and second containers are located on opposite sides of the holder part.

3. The dust container arrangement according to claim 1, wherein the first and second containers are releasably attached to opposite sides of the holder part.

4. The dust container arrangement according to claim 1, wherein the second container constitutes a barrier towards ambient atmospheric pressure during operation.

5. The dust container arrangement according to claim 1, wherein the second container is constituted by a plastic bag and is comprised in an elongated rolled-up or folded plastic tube that gradually is adapted to be unrolled or unfolded when one second container is to be changed, wherein the second container is closed at a bottom of the second container with a bottom sealing means.

6. The dust container arrangement according to claim 5, wherein, when the second container is used and is to be changed, the second container is adapted to be closed at a top of the second container with a top sealing means, and a replacement second container is adapted to be closed at a bottom of the replacement second container with a new bottom sealing means before the second containers and the replacement second container are separated from each other by means of a cut in between the top sealing means and a new bottom sealing clamp.

7. The dust container arrangement according to claim 1, wherein the dust container arrangement comprises a one-way valve arranged at the container inlet and adapted to prevent air and dust to flow from the dust container arrangement, in a direction that is opposite the air and dust flow direction during operation, via the container inlet.

8. The dust container arrangement according to claim 1, wherein the frame further comprises a mobility assembly, wherein the holder part is attached to the mobility assembly by a non-permanent or permanent fastening method.

9. The dust container arrangement according to claim 8, wherein the mobility assembly comprises a handle attached to the holder part, or wherein the mobility assembly comprises a frame and wheels.

10. (canceled)

11. The dust container arrangement according to claim 9, wherein the mobility assembly further comprises supporting means and a base part, wherein the wheels are attached to the base part, wherein the holder part is attached to the base part via the supporting means, and wherein the second container is adapted to run between the holder part and the base part.

12. (canceled)

13. The dust container arrangement according to claim 1, wherein air pressure at the container inlet during operation exceeds ambient atmospheric pressure with less than 0.05 Bar, or
wherein a maximum air pressure at the container inlet exceeds the ambient atmospheric pressure with less than 0.1 Bar.

14. (canceled)

15. The dust container arrangement according to claim 1, wherein the dust container arrangement is adapted to be fluidly coupled to a fan arrangement that is arranged to convey air towards the dust container arrangement and comprises a fan turbine that is connected to a fan pulley, wherein a drive belt comprised in the construction equipment is arranged to propel the fan pulley.

16. The dust container arrangement according to claim 1, wherein the dust container arrangement is adapted to be fluidly coupled to a fan arrangement that is arranged to convey air towards the dust container arrangement, wherein the fan arrangement comprises an electric motor that is powered by means of a battery.

17. The dust container arrangement according to claim 1, wherein, in an idle state, the first container is adapted to be depressed and stored in the holder part.

18. The dust container arrangement according to claim 1, wherein the wall of first container is made of a material with permeable characteristics that, at a maximum air flow for air that is blown into the container inlet of between 30 liters per second, l/s, and 80 l/s, provides a filtering degree of one of:
at least 99.997% for all particles having a size of, or exceeding, 0.3 μm,
at least 99.99% for all particles having a size of, or exceeding, 0.3 μm, or
at least 99.97% for all particles having a size of, or exceeding, 0.3 μm.

19. (canceled)

20. The dust container arrangement according to claim 1, wherein the first container has a shape such that a largest cross-sectional area in a plane perpendicular to a longitudinal extension is present at a first distance from the holder part and a second distance from a top of the first container, the top being a part of the first container adapted to be positioned farthest away from the holder part, wherein the first distance falls below the second distance, and
wherein the largest cross-sectional area exceeds a cross-sectional area of the holding part in a plane perpendicular to the longitudinal extension.

21. (canceled)

22. The dust container arrangement according to claim 1, wherein the dust container arrangement comprises a supporting device that is adapted to maintain the first container in an expanded position, and
wherein the supporting device is a telescopic rod that extends within the first container, or the supporting device is a flexible spiral rod that extends along the wall of the first container.

23. (canceled)

24. The dust container arrangement according claim 8, wherein the mobility assembly comprises wheels arranged to support the mobility assembly on concrete during an early entry sawing process,
wherein the wheels are configured with a diameter between 5-40 cm,
wherein the wheels are configured with a width between 5-15 cm, or
wherein the wheels are coated in a resilient material.

25-27. (canceled)

28. The dust container arrangement according to claim 8, wherein the mobility assembly comprises a drawbar arrangement arranged to couple to construction equipment configured to tow the dust container arrangement, and
wherein the drawbar arrangement is configured with an arcuate shape.

29. (canceled)

30. The dust container arrangement according to claim 1, wherein the dust container arrangement is arranged to be fixedly mounted onto the construction equipment.

31-47. (canceled)
